(19) United States
(12) Patent Application Publication
(10) Pub. No.: US 2009/0046106 A1
(43) Pub. Date: Feb. 19, 2009

(54) Method of displaying images and display apparatus applying the same

(75) Inventors: Sung-ha Park, Seongnam-si (KR); Sung-cheol Bae, Seongnam-si (KR); Won-jung Kim, Seongnam-si (KR); Ji-hyun Goh, Seongnam-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/080,207

(22) Filed: Apr. 1, 2008

(30) Foreign Application Priority Data
Aug. 14, 2007 (KR) 10-2007-0081709

(51) Int. Cl. G09G 5/02

(52) U.S. Cl. 345/589

(57) ABSTRACT

A method of displaying an object image desired by a user on a display apparatus such as an electronic picture frame, without needing to rotate or cut the object image, and a display apparatus to which the method of displaying is applied are provided. The displaying method comprises: determining a background image; generating a display image by synthesizing the background image and an object image; and displaying the display image.

### CROSS-REFERENCE TO RELATED PATENT APPLICATIONS

This application claims the benefit of Korean Patent Application No. 10-2007-0081709, filed on Aug. 14, 2007, in the Korean Intellectual Property Office, the disclosure of which is incorporated herein in its entirety by reference.

### BACKGROUND OF THE INVENTION

1. Field of the Invention

The present invention relates to an apparatus for clearly displaying an object image and a display apparatus to which the method is applied.

2. Description of the Related Art

A variety of digital photographing apparatuses have been developed and introduced in the market recently. The prime advantage of an image captured by a digital photographing apparatus is that the image can be confirmed immediately without a developing process. In other words, the captured image can be promptly confirmed in a display apparatus at the location where they image was captured. By using this advantage, the display apparatus, which can display the image for demonstration purposes without developing the image and placing the image in a picture frame, has been devised.

However, even though an image of an object having a variety of screen ratios can be generated by photographing the object and vertically or horizontally arranging the digital photographing apparatus, the screen dimension of the display unit of the apparatus is fixed. Accordingly, unless the image is rotated or cut, a blank space is inevitably generated when the object image is displayed. This blank space, in return, reduces the display effect of the object image, thereby blurring the demonstration.

### SUMMARY OF THE INVENTION

The present invention provides a method of clearly displaying an object image desired by a user on a display apparatus without needing to rotate or cut the object image.

The present invention also provides a display apparatus to which the displaying method is applied.

According to an aspect of the present invention, there is provided a method of displaying an image in a display apparatus, the method including: determining a background image; generating a display image by synthesizing the background image and an object image; and displaying the display image.

A background image having the same pattern or color as that of the frame of the display apparatus may be determined.

The method may further include sensing the type of frame of the display apparatus.

The method may further include sensing an external illuminance, wherein the background image is determined according to the sensed external illuminance.

In this case, in the determining of the background image, any one from among several background images that are stored in advance may be selected, or the luminance of the selected background image may be adjusted.

More specifically, when an external illuminance is high, a background image having a low brightness may be selected or the luminance of the background image may be reduced. Also, when an external illuminance is relatively low, a background image having a relatively high brightness may be selected or the luminance of the background image may be increased.

The background image having a low brightness means an image formed with dark colors, and the background image having a relatively high brightness means an image formed with relatively bright colors. Hereinafter, these terms will be used to indicate the same meanings.

The background may be determined according to the luminance of the object image.

More specifically, when the luminance of the object image is high, a background image having a low brightness may be selected or the luminance of the background image may be reduced. On the other hand, when the luminance of the object image is relatively low, a background image having a high brightness may be selected or the luminance of the background image may be increased.

Accordingly, by increasing the contrast between the object image and background image desired to be displayed, the object image can be clearly displayed.

According to another aspect of the present invention, there is provided a display apparatus including: a background image determination unit determining a background image; a display image generation unit generating a display image by synthesizing the background image and an object image; and a display unit displaying the display image.

The apparatus may further include a frame surrounding the display unit, wherein the background image determination unit selects a background image having the same pattern or color as that of the frame of the display apparatus.

The apparatus may further include a frame sensing unit sensing the frame, wherein the background image determination unit determines a background image according to a sensing signal from the frame sensing unit.

The apparatus may further include an external luminance sensing unit sensing an external luminance, wherein the background image determination unit determines a background image according to the external luminance sensed by the external illuminance sensing unit.

The background image determination unit may adjust the luminance of the background image according to the external illuminance sensed by the external illuminance sensing unit.

The background image determination unit may determine a background image according to the luminance of the object image.

The background image determination unit may adjust the luminance of the background image according to the luminance of the object image.

The apparatus may further include a background image storage unit storing at least one of the background image, wherein the background image determination unit selects a background image from the background image storage unit.

If the screen ratio of the object image is the same as that of the display unit, the display unit may display a display image formed with the object image, and if the screen ratio of the object image is different from that of the display unit, the display unit may display a display image formed with the background image and the object image.

According to the present invention as described above, when the screen ratio of the display unit of a display apparatus for displaying an object image is different from the ratio of the object image, the blank space is effectively processed, thereby allowing the object image to be clearly displayed.

More specifically, by displaying a background image having the same pattern or color as that of a frame surrounding the display unit, in the blank space, the object image can be effectively displayed. Also, by determining a background image according to an external illuminance and displaying the background image, the contrast of the object image can be improved.

Furthermore, by determining the background image according to the luminance of the object image, the object image can be clearly displayed.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating an electronic picture frame as a display apparatus, according to an embodiment of the present invention;

FIG. 2 is a flowchart illustrating a method of displaying an image in the electronic picture frame illustrated in FIG. 1, according to an embodiment of the present invention;

FIG. 3 is a diagram illustrating a screen displaying an object image in an electronic picture frame according to the flowchart of the method illustrated in FIG. 2, according to an embodiment of the present invention;

FIG. 4 is a block diagram illustrating an electronic picture frame as a display apparatus according to an embodiment of the present invention;

FIGS. 5A and 5B are diagrams illustrating perspective views of the electronic picture frame illustrated in FIG. 4 according to embodiments of the present invention;

FIG. 6 is a flowchart illustrating a method of displaying an image in the electronic picture frame illustrated in FIG. 4, according to an embodiment of the present invention;

FIG. 7 is a block diagram illustrating an electronic picture frame according to another embodiment of the present invention;

FIG. 8 is a flowchart illustrating a method of displaying an image in the electronic picture frame illustrated in FIG. 7, according to an embodiment of the present invention;

FIG. 9 is a flowchart illustrating a method of displaying an image in the electronic picture frame illustrated in FIG. 7, according to another embodiment of the present invention; and

FIG. 10 is a flowchart illustrating a method of displaying an image in the electronic picture frame illustrated in FIG. 1, according to an embodiment of the present invention.

### DETAILED DESCRIPTION OF THE INVENTION

The present invention will now be described more fully with reference to the accompanying drawings, in which exemplary embodiments of the invention are shown. Hereinafter, in the embodiments of the present invention, an electronic picture frame capable of displaying an object image desired by a user will be explained as a display apparatus of the present invention.

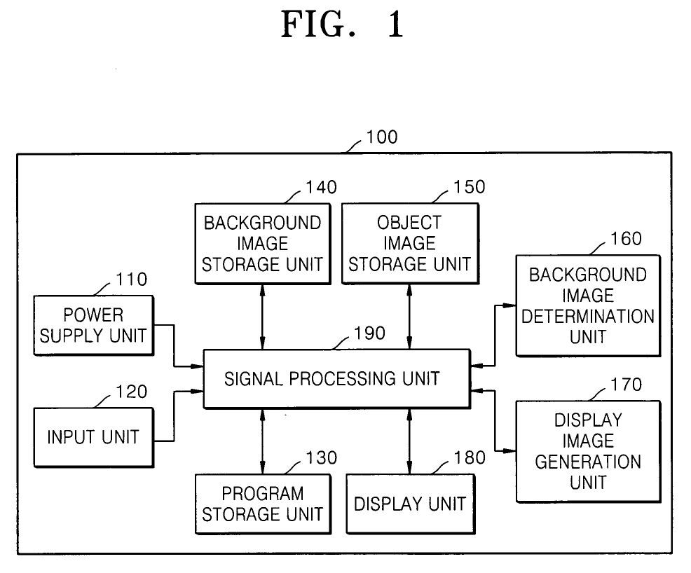

FIG. 1 is a block diagram illustrating an electronic picture frame 100 according to an embodiment of the present invention.

Referring to FIG. 1, the electronic picture frame 100 includes a power supply unit 110, an input unit 120, a program storage unit 130, a background image storage unit 140, an object image storage unit 150, a background image determination unit 160, a display image generation unit 170, a display unit 180, and a signal processing unit 190.

The power supply unit 110 provides predetermined power to the electronic picture frame 100, thereby allowing the electronic picture frame 100 to operate. The power supply unit 110 may include an external battery, an internal battery, and a converter for stable power supply.

The input unit 120 receives control signals from, for example, a keypad, an on screen display (OSD), or a remote controller.

The program storage unit 130 stores a program required for operating the electronic picture frame 100. The program storage unit 130 may be a semiconductor device such as a read-only memory (ROM).

The background image storage unit 140 can store at least one background image. The background image storage unit 140 may be an internal storage unit included in the electronic picture frame 100 or an external storage unit, which is attachable to and detachable from the electronic picture frame 100.

The external storage unit can be connected to the electronic picture frame 100 in a wired or wireless manner.

The object image storage unit 150 stores an object image desired by a user to be displayed, and can also store a plurality of object images. The object image storage unit 150 can also be either an internal storage unit included in the electronic picture frame 100 or an external storage unit.

The background image determination unit 160 selects a predetermined background image from the background image stored in the background image storage unit 140 or adjusts the luminance of the selected background image. The background image determination unit 160 can determine a background image according to the type of frame surrounding the display unit 180, external illuminance, the luminance of an object image, and the like.

The display image generation unit 170 synthesizes the background image determined in the background image determination unit 160 and an object image to be displayed, thereby generating a display image. The display image generation unit 170 may be formed with a semiconductor memory device such as a random access memory (RAM). More specifically, the display image generation unit 170 writes data of a background image in a memory area, and then, overwrites the data of an object image on the memory area in which the background image data is written. Accordingly, if a screen ratio of the display unit 180 is different from that of the object image, the object image data is written only on a part of the memory area, and the background image is written on the remaining part of the memory area, thereby allowing a display image including the object image and the background image to be generated. Also, if the screen ratio of the display unit 180 is the same as that of the object image, the background image is written on the memory area and the object image is overwritten on the whole written background image, thereby generating a display image formed as the object image.

The display unit 180 displays the display image from the display image generation unit 170. More specifically, if the screen ratio of the display unit 180 is different from that of the object image, a display image formed with the background image and the object image is displayed. If the screen ratio of the display unit 180 is the same as that of the object image, a display image formed as the object image is displayed. The display unit 180 may include any of a variety of flat panel display apparatuses, such as a liquid crystal display (LCD), or an organic light-emitting diode (OLED), or similar apparatus.

The signal processing unit 190 processes a signal for controlling the electronic picture frame 100 so that an operation of a corresponding mode can be performed.

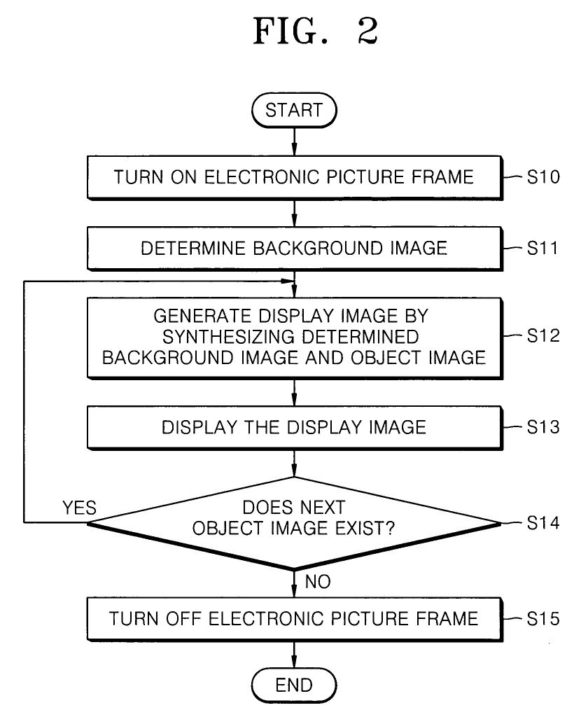

FIG. 2 is a flowchart illustrating a method of displaying an image in the electronic picture frame 100 illustrated in FIG. 1, according to an embodiment of the present invention.

Referring to FIG. 2, the power of the electronic picture frame 100 is turned on in operation S10. A background image is determined in operation S11. The background image may be selected manually by a user, or may be automatically determined according to the type of electronic picture frame, external illuminance, and the luminance of an object image, as will be explained later.

Then, by synthesizing the determined background image with an object image, a display image is generated in operation S12. If the screen ratio of the object image is the same as that of the display unit 180, the background image is written in a memory area of the display unit 180. However, if the screen ratio of the object image is different from that of the display unit 180, the background image is written in the whole memory area of the display unit 180, and the object image is overwritten on a part of the background image. As a result, the object image is written in part of the memory area and the background image is written in the remaining part of the memory area. Accordingly, a display image formed with the background image and the object image can be displayed. That is, at least a portion of the background image will be displayed.

After the display image is generated, the display image is displayed in operation S13. As a displaying method, a single image may be displayed. However, in the current embodiment, a method of displaying a plurality of object images in a slide show manner is suggested. Accordingly, after displaying the display image, it is determined whether or not a next object image exists in operation S14.

If the next object image exists, the determined background image determined in operation S11 is synthesized with the next object image, thereby generating a display image in operation S12, and displaying the generated display image. If, in operation S14 there are no further object images to display, the display image formed by synthesizing the previous object image may be continuously displayed or the power of the electronic picture frame is turned off, in operation S15. Alternatively, the process may return to operation S11 and the first object image will be displayed.

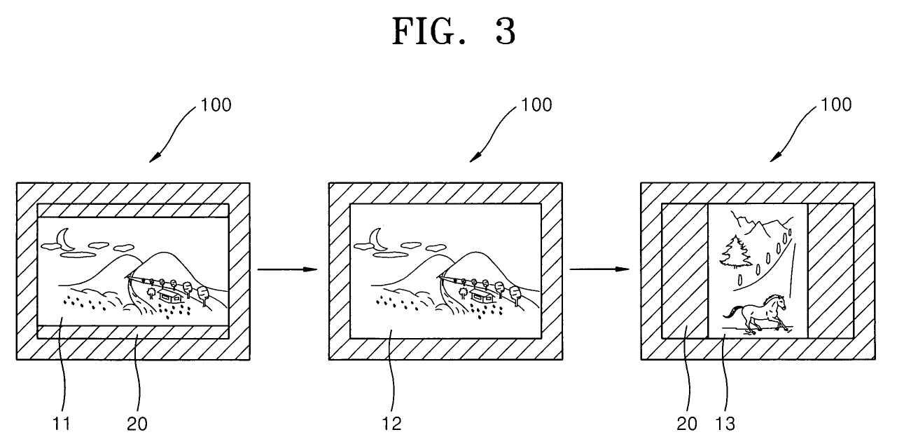

According to the method of displaying an image in an electronic picture frame 100 as described above, an object image can be displayed as illustrated in FIG. 3.

More specifically, referring to FIG. 3, a background image 20 is determined, and then, by synthesizing a first object image 11 having a screen ratio of 16:9 with the background image 20, a display image is displayed. The display unit 180 has a screen ratio of 4:3, which is different from that of the first object image 11. Accordingly, the first object image 11 is displayed on a part of the display unit 180, and the background image 20 is displayed in the remaining part of the display unit 180.

A second object image 12 has the same screen ratio as that of the display unit 180. Accordingly, if the second object image 12 is synthesized with the determined background image 20, a display image formed only with the second object image 12 is generated, and this display image is displayed on the whole display unit 180. That is, only the second object image 12 is displayed on the display unit 180.

A third object image 13 is a vertical image having a screen ratio of 3:4. By synthesizing the third object image 13 with the background image 20, a display image is generated and displayed. Then, the third object image 13 is displayed on a part of the display unit 180, and the background image 20 is displayed on the remaining area of the display unit 180.

In particular, in the current embodiment, by determining the background image 20 to have the same pattern and color as those of the frame of the electronic picture frame 100, the remaining area excluding the area in which the object image is displayed in the display unit 180 appears as a portion of the electronic picture frame 100, thereby increasing the display effect of the object image.

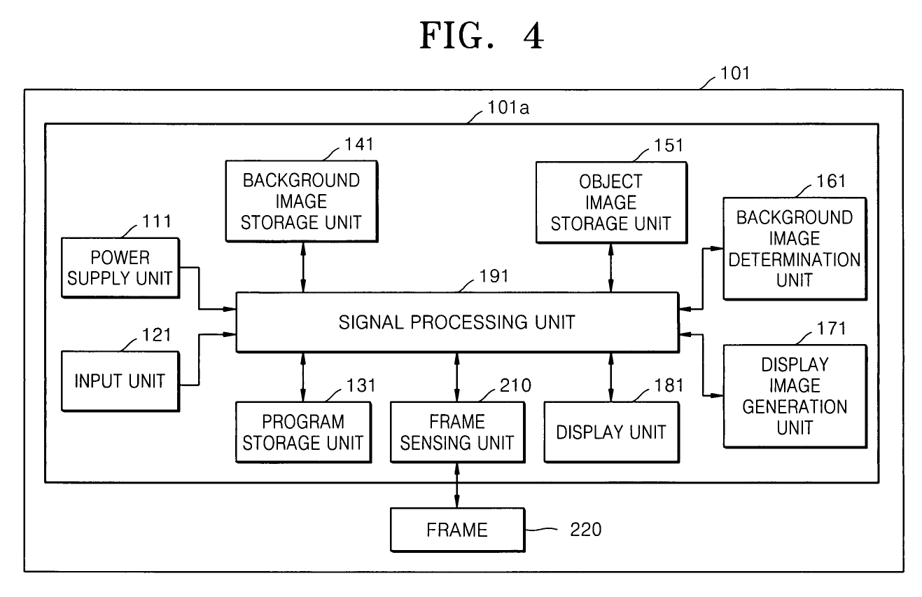

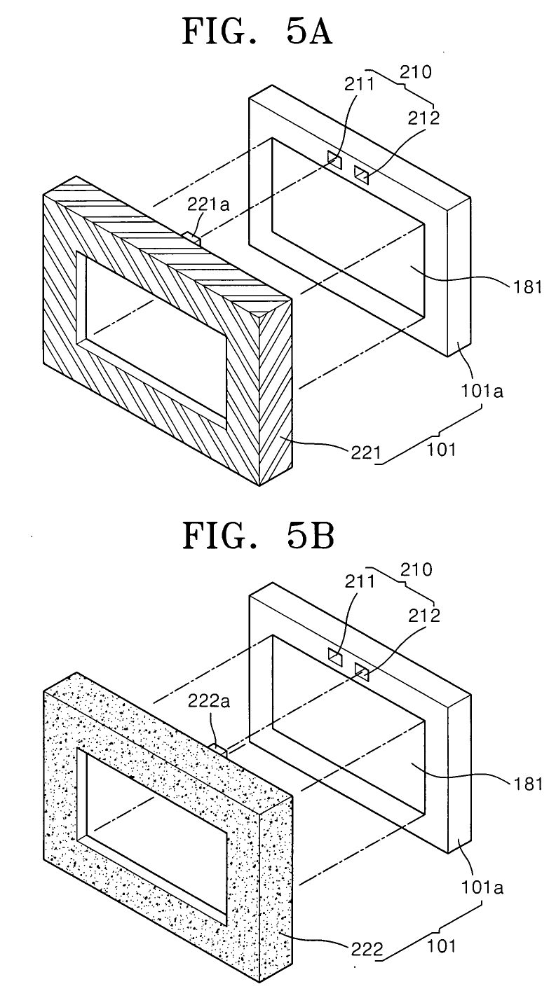

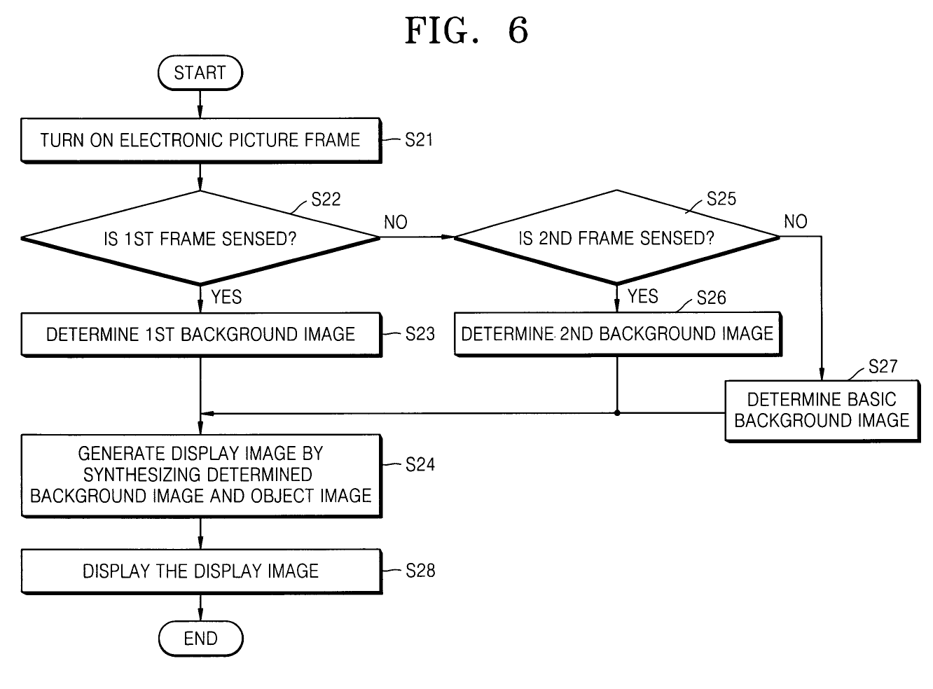

FIG. 4 is a block diagram illustrating an electronic picture frame 101 according to an embodiment of the present invention. FIGS. 5A and 5B are diagrams illustrating perspective views of the electronic picture frame 101 illustrated in FIG. 4, according to an embodiment of the present invention. FIG. 6 is a flowchart illustrating a method of displaying an image in the electronic picture frame 101 illustrated in FIG. 4, according to an embodiment of the present invention.

The electronic picture frame 101 and the method of displaying an image in the electronic picture frame 101 are essentially the same as the electronic picture frame 100 illustrated in FIG. 1 and the method of displaying an image in the electronic picture frame illustrated 100 in FIG. 2 in that a background image is determined, a display image is generated by synthesizing the background image and an object image, and thus a generated display image is displayed. Accordingly, a method of determining a background image according to the type of frame when the background image is determined and displaying the determined background image in a display unit, which is not explained for the electronic picture frame 100 illustrated in FIG. 1 and the method of displaying an image in the electronic picture frame 100 illustrated in FIG. 2, will now be explained in more detail.

First, the electronic picture frame 101 will be explained. Referring to FIG. 4, the electronic picture frame 101 includes a power supply unit 111 supplying predetermined power, an input unit 121 receiving an external signal so that the electronic picture frame 101 can operate, a program storage unit 131 storing a program for driving the electronic picture frame 101, a background image storage unit 141 storing at least one background image, an object image storage unit 151 storing an object image, a background image determination unit 161 determining a background image, a display image generation unit 171 generating a display image by synthesizing the background image and the object image, a display unit 181 displaying the display image, and a signal processing unit 191 controlling each unit of the electronic picture frame 101 and processing a signal so that a corresponding mode can be performed.

In particular, the electronic picture frame 101 according to the current embodiment includes a first frame 221 surrounding the display unit 181 and a frame sensing unit 210 sensing the type of frame. Referring to FIG. 5A, for example, the frame sensing unit 210 includes first and second holes 211 and 212 and circuits connected to the holes 211 and 212, respectively. In the first frame 221, a first protrusion unit 221A is formed at a location corresponding to the first hole 211.

The first protrusion unit 221A and the first hole 211 may be formed as conductors. Accordingly, if the first frame 221 is mounted on a main body 101A of the frame sensing unit 210, the first protrusion unit 221A extends into the first hole 211, and the circuit connected to the first hole 211 is connected, thereby allowing the frame sensing unit 210 to sense that the connected frame is the first frame 221.

Also, referring to FIG. 5B, if a second frame 222 is mounted on the main body 101A of the frame sensing unit 210, a second protrusion 222A of the second frame 222 extends into the second hole 212, and the circuit connected to the second hole 212 is connected, thereby allowing the frame sensing unit 210 to sense that the connected frame is the second frame 222.

The method of sensing the type of frame in the frame sensing unit 210 is not limited to the method described above, and a variety of methods can be used to sense the type of frame. For example, by attaching a barcode to a frame and mounting a barcode reader on a main body, the type of frame can be sensed.

As described above, the type of frame is sensed by the frame sensing unit 210, and a background image having the same pattern or color as that of the frame is selected in the background image determination unit 161. For example, if the first frame 221 having a stripe pattern is sensed by the frame sensing unit 210, the background image determination unit 161 selects a first background image having the stripe pattern from the background image storage unit 141, and if a second frame 222 having a spot pattern is sensed by the frame sensing unit 210, the background image determination unit 161 selects a second background image having the spot pattern.

The method of displaying an image of an electronic picture frame will now be explained with reference to FIG. 6 in more detail. FIG. 6 is a flowchart illustrating a method of displaying an image in the electronic picture frame 101 illustrated in FIG. 4, according to an embodiment of the present invention

First, the power of the electronic picture frame 101 is turned on in operation S21. In operation S22, it is determined whether or not the first frame 221 is sensed.

If the first frame 221 is sensed, a first background image is determined in operation S23. Then, by synthesizing the first background image and an object image, a display image is generated in operation S24.

If the first frame 221 is not sensed, it is determined whether or not the second frame 222 is sensed in operation S25. If the second frame 222 is sensed, a second background image is determined in operation S26, and by synthesizing the second background image and an object image, a display image is generated in operation S24.

If the second frame 222 is not sensed either, a basic background image such as a black screen is determined in operation S27, and by synthesizing the basic background image with an object image, a display image is generated in operation S24.

Then, the display image is displayed in operation S28. In this case, one object image may be displayed, or by using a plurality of object images, a plurality of display images may be generated and displayed in a slide show manner.

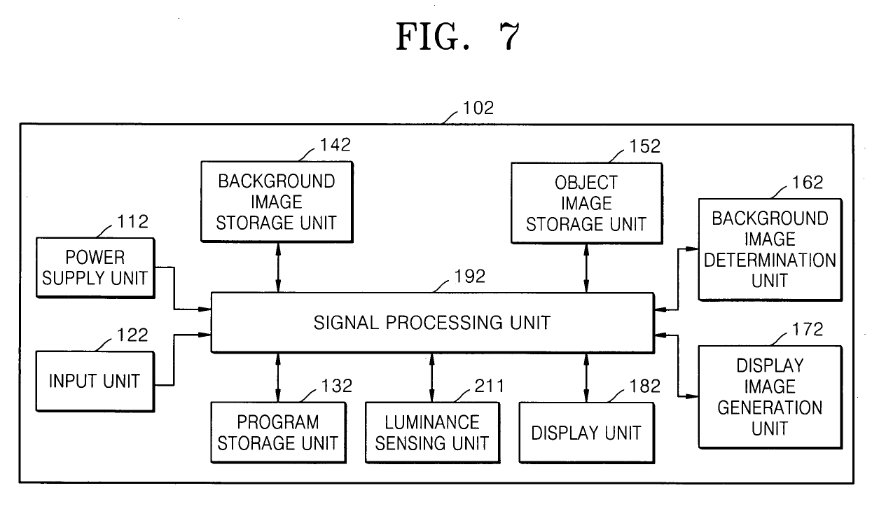

FIG. 7 is a block diagram illustrating an electronic picture frame 102 according to another embodiment of the present invention.

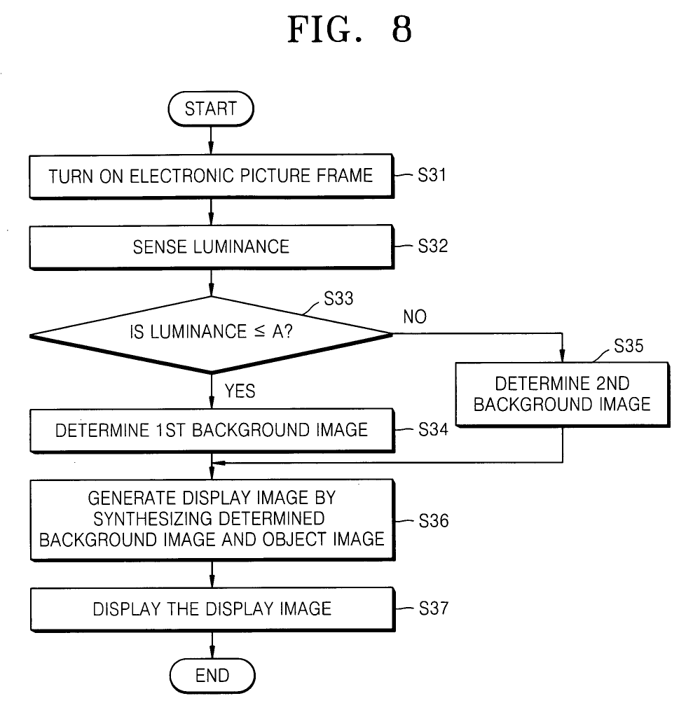

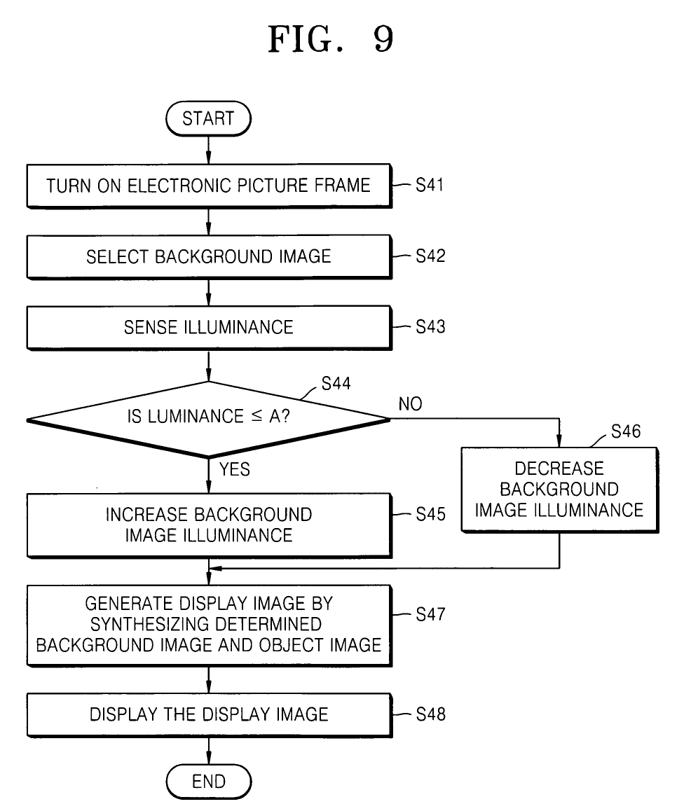

FIG. 8 is a flowchart illustrating a method of displaying an image in the electronic picture frame 102 illustrated in FIG. 7, according to an embodiment of the present invention. FIG. 9 is a flowchart illustrating a method of displaying an image in the electronic picture frame 102 illustrated in FIG. 7, according to another embodiment of the present invention.

The electronic picture frame 102 and the method of displaying an image in the electronic picture frame 102 according to the current embodiments are essentially the same as the electronic picture frame 100 illustrated in FIG. 1 and the method of displaying an image in the electronic picture frame 100 illustrated in FIG. 2 in that a background image is determined, a display image is generated by synthesizing the background image and an object image, and the thus the display image is displayed. However, in the electronic picture frame 102, the background image is determined according to an external illuminance. A method of displaying an image in the electronic picture frame 102 will now be explained in detail.

Referring to FIG. 7, the electronic picture frame 102 includes a power supply unit 112 supplying predetermined power to the electronic picture frame 102, an input unit 122 receiving an external signal so that the electronic picture frame 102 can operate, a program storage unit 132 storing a program for driving the electronic picture frame 102, a background image storage unit 142 storing at least one background image, an object image storage unit 152 storing an object image, a background image determination unit 162 determining a background image, a display image generation unit 172 generating a display image by synthesizing the background image and the object image, a display unit 182 displaying the display image, and a signal processing unit 192 controlling each unit of the electronic picture frame 102 and processing a signal so that a corresponding mode can be performed. In addition, there is provided a luminance sensing unit 211 for sensing the external luminance of the electronic picture frame 102.

The background image determination unit 142 selects a background image according to the luminance of an object image or adjusts the luminance of the background image.

Determining a background image according to the external luminance will now be explained in more detail with reference to FIG. 8 also. First, the power of the electronic picture frame 102 is turned on in operation S31, and an external luminance is sensed by the luminance sensing unit 211 in operation S32.

In operation 533, it is determined whether or not the sensed luminance is equal to or less than a predetermined reference value ‘a’. This determination can be performed in the signal processing unit 192. If it is determined in the signal processing unit 192 that the sensed luminance is equal to or less than the predetermined reference value ‘a’, a control signal corresponding to the determination result is transferred to the background image determination unit 162, and a first background image from the background image storage unit 142 is determined by the background image determination unit 162 in operation S34. Also, if the sensed luminance is greater than the predetermined reference value ‘a’, a second background image is determined in operation S35.

That is, if the sensed external luminance is relatively low, a first background image having a first brightness of a bright color is selected. In this case, the predetermined value ‘a’ may be a value preset by a user or a value automatically set through construction of a database of the electronic picture frame 102. Also, if the sensed external luminance is greater than the value ‘a’, that is, the sensed external luminance is relatively high, a second background image formed with a dark color, that is, having a second brightness lower than the first brightness, is selected.

Then, by synthesizing the determined background image and an object image, a display image is generated in operation S36, and the display image is displayed in operation S37. In this case, a single image may be displayed or a plurality of images may be displayed in a slide show manner.

Another method of displaying an image in the electronic picture frame 102 is illustrated in FIG. 9. FIG. 9 is a flowchart illustrating a method of displaying an image in the electronic picture frame 102 illustrated in FIG. 7, according to another embodiment of the present invention; Referring to FIG. 9, the power of the electronic picture frame 102 is turned on in operation S41 and a background image is selected in operation S42.

Then, an external luminance is sensed in operation S43, and it is determined whether or not the sensed external luminance is equal to or less than a predetermined reference value ‘a’ in operation S44. If the external luminance is equal to or less than the predetermined reference value ‘a’, the luminance of the selected background image is increased in operation S46. Also, if the second external luminance is greater than the predetermined reference value ‘a’, the luminance of the background image is decreased. For the adjustment of the luminance of the background image, the luminance may be increased or decreased by adjusting the image data value of the background image. A control signal according to the determination result and a control signal for the adjustment of the luminance of the background image can be generated in the signal processing unit 192. The background image may be selected in advance or after sensing the luminance and by comparing the sensed luminance with a predetermined reference value, a background image may be selected.

The background image having the adjusted luminance and an object image are synthesized, thereby generating a display image in operation S47. Then, the display image is displayed in operation S48.

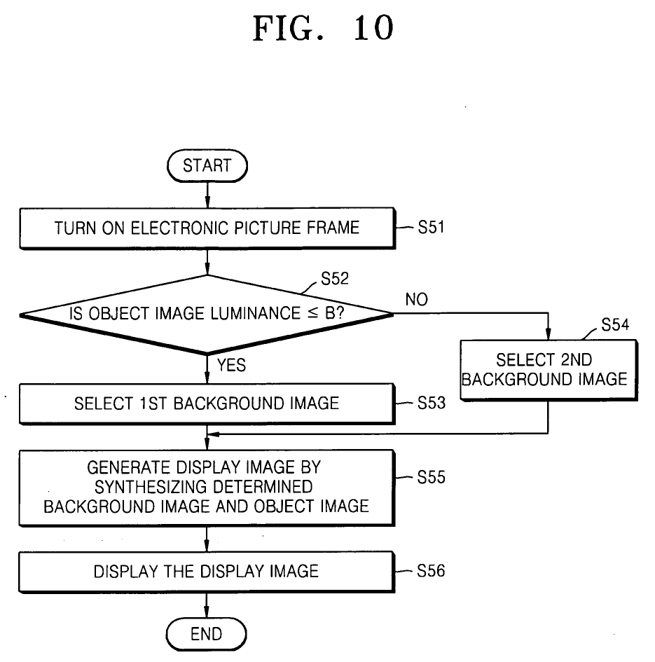

FIG. 10 is a flowchart illustrating a variation of displaying an image in the electronic picture frame 100 illustrated in FIG. 1, according to an embodiment of the present invention. According to this alternative method, the background image is selected based upon the luminance of the object image to be displayed.

More specifically, referring to FIG. 10 also, if a user controls the electronic picture frame 100 through the input unit 120 so that the power of the electronic picture frame 100 can be turned on, predetermined power is supplied from the power supply unit 110 and the power of the electronic picture frame 100 is on in operation S51.

Then, it is determined in the signal processing unit 190 whether or not the luminance of an object image is equal to or less than a predetermined reference value ‘b’ in operation S52. If the determination result indicates that the luminance of the object image is equal to or less than a predetermined reference value ‘b’, a control signal corresponding to the determination result is provided to the background image determination unit 160, and according to the control signal, the background image determination unit 160 selects a first background image stored in the background image storage unit 140 in operation S53.

Also, if the determination result indicates that the luminance of the object image is greater than the predetermined reference value ‘b’, a control signal corresponding to the determination result is transmitted from the signal processing unit 190 to the background image determination unit 160, and the background image determination unit 160 selects a second background image from the background image storage unit 140 according to the control signal in operation S54. Accordingly, the background image is determined.

More specifically, if the luminance of the object image is relatively low, a first background image having a first brightness with a bright color is selected. In this case, the predetermined value ‘b’ may be a value preset by a user or a value automatically set through construction of a database of the electronic picture frame 100. Also, if the luminance of the object image is greater than the predetermined reference value ‘b’, that is, if the luminance of the object image is relatively high, a second background image with a dark color and having a second brightness lower than the first brightness, can be selected.

Then, by synthesizing the background image and the object image, a display image is generated in operation S55, and the display image is displayed in operation S56. In this case, a single image may be displayed or a plurality of images may be displayed in a slide show manner.

Though not shown, the luminance of the background image may be adjusted according to the luminance of the object image. For example, if the luminance of the object image is equal to or less than a predetermined value ‘b’, the luminance of the background image may be increased, and if the luminance of the object image is greater than the predetermined value ‘b’, the luminance of the background image may be decreased.

Accordingly, by increasing the contrast between an object image and a background image, the object image can be clearly displayed.

While the present invention has been particularly shown and described with reference to exemplary embodiments thereof, it will be understood by one of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of displaying an image in a display apparatus, the method comprising:
selecting a background image;
generating a display image by synthesizing the background image and an object image; and
displaying the display image.

2. The method of claim 1, wherein a background image is selected based upon visual characteristics of a frame of the display apparatus.

3. The method of claim 2, wherein the background image selected has a similar pattern or color as the frame of the display apparatus.

4. The method of claim 2, further comprising sensing the type of frame of the display apparatus.

5. The method of claim 1, further comprising sensing an external illuminance, wherein the background image is selected based upon the sensed external illuminance.

6. The method of claim 1, further comprising determining the luminance of the object image, wherein the background is selected based upon the luminance of the object image.

7. The method of claim 5, further comprising adjusting the luminance of the background image.

8. The method of claim 5, further comprising adjusting the luminance of the object image.

9. A display apparatus comprising:
a background image determination unit selecting a background image;
a display image generation unit generating a display image by synthesizing the background image and an object image; and
a display unit displaying the display image.

10. The apparatus of claim 9, further comprising a frame surrounding the display unit, wherein the background image determination unit selects a background image having a visual characteristic similar to that of the frame of the display apparatus.

11. The apparatus of claim 10, wherein the visual characteristic is selected from the group consisting of color and pattern.

12. The apparatus of claim 10, further comprising a frame sensing unit sensing the frame, wherein the background image determination unit selects a background image based upon information from the frame sensing unit.

13. The apparatus of claim 9, further comprising an external luminance sensing unit sensing an external illuminance, wherein the background image determination unit selects a background image based upon information from the external illuminance sensing unit.

14. The apparatus of claim 13, wherein the background image determination unit adjusts the luminance of the background image based upon information from the external illuminance sensing unit.

15. The apparatus of claim 9, wherein the background image determination unit selects a background image based upon the luminance of the object image.

16. The apparatus of claim 15, wherein the background image determination unit adjusts the luminance of the background image based upon the luminance of the object image.

17. The apparatus of claim 9, further comprising a background image storage unit storing at least one background image, wherein the background image determination unit selects a background image from the background image storage unit.

18. The apparatus of claim 9, wherein if the screen ratio of the object image is the same as that of the display unit, the display unit displays a display image formed with the object image, and if the screen ratio of the object image is different from that of the display unit, the display unit displays a display image formed with the background image and the object image.
